(19) United States
(12) Patent Application Publication
(10) Pub. No.: US 2011/0261198 A1
(43) Pub. Date: Oct. 27, 2011

(54) DATA TRANSMISSION METHOD AND DEVICE

(75) Inventor: Yoko SAITO, SAITAMA (JP)

(73) Assignee: HONDA MOTOR CO., LTD., TOKYO (JP)

(21) Appl. No.: 13/088,547

(22) Filed: Apr. 18, 2011

(30) Foreign Application Priority Data
Apr. 26, 2010 (JP) 2010-101314

(51) Int. Cl. H04N 7/18

(52) U.S. Cl. 348/148; 348/143; 901/1; 901/47

(57) ABSTRACT

In a data transmission method, a data transfer module 40 for transmitting an image frame of a predetermined image format and an audio frame of a predetermined audio format is used. The data transmission method includes: a step of acquiring image data captured by a pair of cameras 8, together with a time stamp indicating an imaging time of the image data, and generating an image frame; a step of acquiring relevant data acquired at the imaging time, together with the time stamp indicating the imaging time; and a step of acquiring the image frame and the relevant data that have the common time stamp, and transmitting, using the data transfer module 40, a relevant frame together with the image frame converted in the image format, the relevant frame being composed of the relevant data stored in an audio data storage area in the audio format.

### BACKGROUND OF THE INVENTION

1. Field of the Invention The present invention relates to a data transmission method and a data transmission device.

2. Description of the Related Art

In the case of executing an application of image processing or the like using image data acquired by an imaging device which is mounted in a mobile body such as a robot or a vehicle, relevant data about the mobile body at the time of the image data acquisition is necessary. For example, in the case where image processing is performed using image data acquired by an imaging device mounted in a head of a robot in order to recognize a position of an object, at least data about a posture of the head at the time of the image data acquisition is necessary. Moreover, to meet a requirement for real-time processing, synchronization between the image data and the relevant data that is acquired at the same time as the image data needs to be ensured when these data are handled by an application device.

Japanese Patent Application Laid-Open No. 2008-259808 discloses a technique of capturing an image by a video camera and audio by a microphone and synchronously transferring facial expression and audio information.

In view of this, a conceivable first method is that the relevant data acquired at the same time as the image data is embedded in the image data and transmitted.

Alternatively, a conceivable second method is that the image data and the relevant data are transmitted by different data transfer modules through separate paths, and synchronized by a receiver.

However, in the above-mentioned first method, since the image data in which the relevant data is embedded is different from the original image data, an image processing application whose processing result is significantly influenced by a slight data change cannot be executed.

Besides, to meet the requirement for real-time processing, it is necessary to perform compression to an amount of data that can be transmitted per unit time. Here, the embedded relevant data cannot be restored if a codec of a lossy compression scheme is used, and accordingly a codec of a lossless compression scheme needs to be used. However, the codec of the lossless compression scheme typically requires a prolonged compression time, and is more expensive than the codec of the lossy compression scheme in order to ensure real-time processing.

By reducing an image data amount by, for example, reducing an image size or the number of image frames per unit time, it is possible to transmit data in uncompressed form. The reduction in image data amount, however, causes a decrease in image analysis accuracy. Moreover, a high-performance device or a dedicated device is needed in order to realize a data transfer module capable of transmitting a large amount of data in uncompressed form, which causes an increase in cost.

On the other hand, in the above-mentioned second method, a larger number of data transfer modules, receivers, and transmission cables connecting them are necessary. This causes an increase in size and weight of a transmission/reception system, leading to poor operability. Besides, it is extremely difficult to synchronize the image data and the relevant data in the receiver. For example, suppose transmission cables of different types are used for the image data and the relevant data, such as in the case where an Ethernet (registered trademark) cable is used for the image data and a USB cable is used for the relevant data. Since the two cables have different operation clock sources, it is impossible to establish perfect synchronization at input terminals of the receiver, and a new mechanism for synchronization needs to be employed.

### SUMMARY OF THE INVENTION

In view of the points stated above, the present invention has an object of providing a data transmission method and device that can synchronize image data captured by an imaging device mounted in a mobile body and relevant data about the mobile body at the time of the image data acquisition, and transmit the synchronized image data and relevant data in real time using a commercially available data transfer module.

The data transmission method according to the present invention is a data transmission method for synchronously transmitting image data and relevant data using a data transfer module, the image data being captured by an imaging device included in a mobile body, the relevant data being data about the mobile body, and the data transfer module transmitting an image frame of a predetermined image format and an audio frame of a predetermined audio format, the data transmission method including: a step of acquiring the image data captured by the imaging device, together with imaging time data indicating an imaging time of the image data, and generating an image frame; a step of acquiring the relevant data acquired at the imaging time, together with the imaging time data indicating the imaging time; and a step of acquiring the image frame and the relevant data that have the common imaging time data, and transmitting, using the data transfer module, the relevant data stored in an audio data storage area in the audio format, together with the image frame converted in the image format.

With the data transmission method according to the present invention, the relevant data stored in the audio data storage area in the audio format that is used in the case where the data transfer module transmits the audio frame is transmitted together with the image frame having the imaging time data in common with the relevant data, using the data transfer module. This ensures that the image frame and the relevant data having the common imaging time are synchronously transmitted.

In addition, the image frame and the relevant data are synchronously transmitted, using the data transfer module for transmitting the image frame of the predetermined image format and the audio frame of the predetermined audio format. This allows a commercially available, inexpensive data transfer module to be used as the data transfer module.

Moreover, in the data transmission method according to the present invention, it is preferable that, in the case where the image frame and the relevant data that have the common imaging time data are acquired, the relevant data is temporarily stored in a blank data area in the image frame, the blank data area being outside an area in which the image data is stored in the image frame.

In this case, the relevant data having the imaging time data in common with the image frame is stored in the blank data area outside the area in which the image data is stored in the image frame. In this state, these data can be synchronously output.

Moreover, in the data transmission method according to the present invention, it is preferable that the data transfer module transmits data using a lossy compression scheme.

In this case, the data transfer module compresses the data using the lossy compression scheme and transmits the compressed data. This contributes to a reduced compression time and a reduced transmission data amount, and also allows the use of an inexpensive data transfer module, as compared with the case where a lossless compression scheme is used.

Moreover, in the data transmission method according to the present invention, it is preferable to include a step of receiving the image frame and the relevant data transmitted from the data transfer module, generating a reception counter indicating a time at which the image frame and the relevant data are received, and adding the reception counter to each of the image frame and the relevant data.

In this case, the image frame and the relevant data having the common imaging time can be associated with each other by the reception counter.

The data transmission device according to the present invention is a data transmission device which synchronously transmits image data and relevant data using a data transfer module, the image data being captured by an imaging device included in a mobile body, the relevant data being data about the mobile body, and the data transfer module transmitting an image frame of a predetermined image format and an audio frame of a predetermined audio format, the data transmission device including: an image frame generator which acquires the image data captured by the imaging device, together with imaging time data indicating an imaging time of the image data, and generates an image frame; a relevant data acquirer which acquires the relevant data acquired at the imaging time, together with the imaging time data indicating the imaging time; and a transmission frame generator which acquires the image frame and the relevant data that have the common imaging time data, and generates an image frame/relevant data that is composed of the image frame converted in the image format and the relevant data stored in an audio data storage area in the predetermined audio format, wherein the image frame and the relevant data generated by the transmission frame generator is transmitted using the data transfer module.

With the data transmission device according to the present invention, the relevant data stored in the audio data storage area in the audio format that is used in the case where the data transfer module transmits the audio frame is transmitted together with the image frame having the imaging time data in common with the relevant data, using the data transfer module. This ensures that the image frame and the relevant data having the common imaging time are synchronously transmitted.

In addition, the image frame and the relevant data are synchronously transmitted, using the data transfer module for transmitting the image frame of the predetermined image format and the audio frame of the predetermined audio format. This allows a commercially available, inexpensive data transfer module to be used as the data transfer module.

Moreover, in the data transmission device according to the present invention, for example, the mobile body is a robot. In this case, it is preferable that the relevant data acquirer acquires at least external information which is obtained by the robot from outside the robot, as the relevant data. It is also preferable that the relevant data acquirer acquires at least internal information which is obtained by the robot from inside the robot, as the relevant data.

Moreover, in the data transmission device according to the present invention, for example, the mobile body is a vehicle. In this case, it is preferable that the relevant data acquirer acquires at least external information which is obtained by the vehicle from outside the vehicle, as the relevant data. It is also preferable that the relevant data acquirer acquires at least internal information which is obtained by the vehicle from inside the vehicle, as the relevant data.

### BRIEF DESCRIPTION OF THE DRAWINGS

FIG. 1 is a perspective view showing a schematic structure of a robot according to an embodiment of the present invention.

FIG. 2 is a block diagram showing an internal structure of the robot and an application device.

FIG. 3 is a flowchart showing data processing in a control unit.

FIG. 4 is a flowchart showing data processing in the application device.

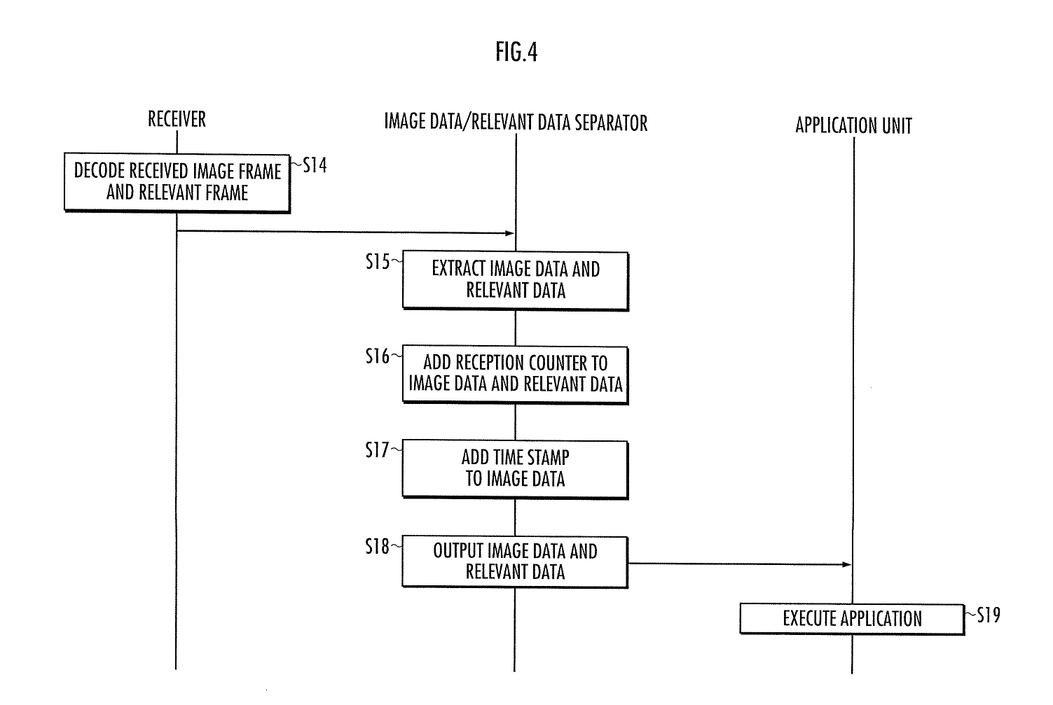

FIG. 5 is a diagram schematically showing storage states of image data and relevant data, where FIG. 5(a) shows an image frame in an image frame generator, FIG. 5(b) shows a state where the relevant data is embedded in a blank area of the image frame in the image frame generator, FIG. 5(c) is a state where the image data and the relevant data are separated from each other in an image data/relevant data separator, and FIG. 5(d) shows a state where a reception counter is added in the image data/relevant data separator.

FIG. 6 is a diagram showing an example where a relevant frame is stored in an audio data storage area in an audio frame format.

FIG. 7 is a perspective view showing a schematic structure of a vehicle according to another embodiment of the present invention.

### DESCRIPTION OF THE PREFERRED EMBODIMENTS

The following describes a robot 1 that includes a data transmission device according to an embodiment of the present invention and that implements a data transmission method according to the embodiment of the present invention, with reference to drawings. The robot 1 is an example of a mobile body of the present invention.

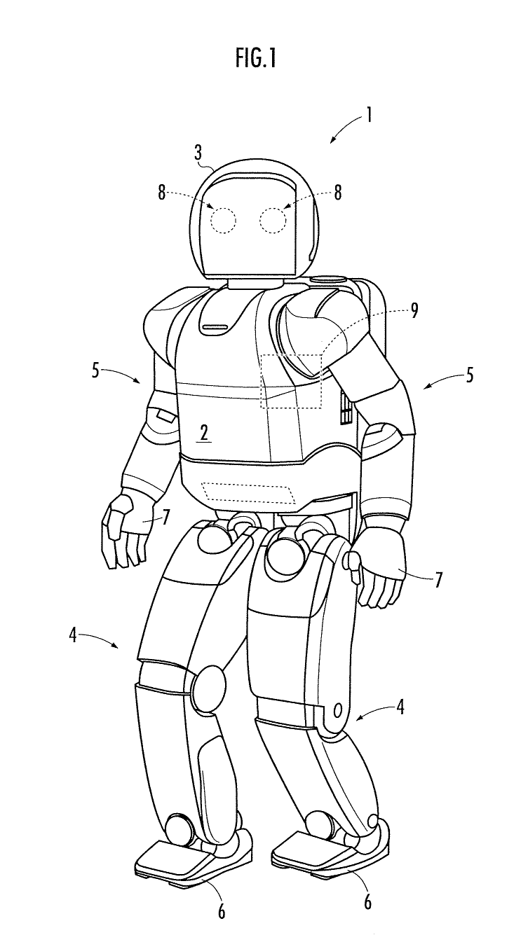

For instance, as shown in FIG. 1, the robot 1 is a humanoid robot including a body 2, a head 3, a pair of legs 4, and a pair of arms 5, where the head 3, the pair of legs 4, and the pair of arms 5 are connected to the body 2 via joints (a neck joint, a hip joint, and a shoulder joint). The body 2 is made up of an upper body and a lower body connected via a waist joint. Each leg 4 has a foot 6 at its end, and includes a plurality of joints (such as a knee joint and an ankle joint). Each arm 5 has a hand 7 at its end, and includes a plurality of joints (such as an elbow joint and a wrist joint).

A camera 8 which is an imaging device for capturing an external image is mounted in the head 3. Here, a pair of left and right cameras 8 are provided. Each camera 8 includes an image sensor array in which photoelectric converters such as CCD sensors are arranged in an array, and a lens through which an optical image converges on a surface of the image sensor array. The image is generated on the image sensor array through the lens, and light in each picture element, i.e., each pixel, is converted to an analog signal and output from the camera 8.

The robot 1 also includes a control unit 9 that performs various kinds of control relating to the robot 1, in the body 2. The control unit 9 is formed by an electronic circuit unit having a microcomputer.

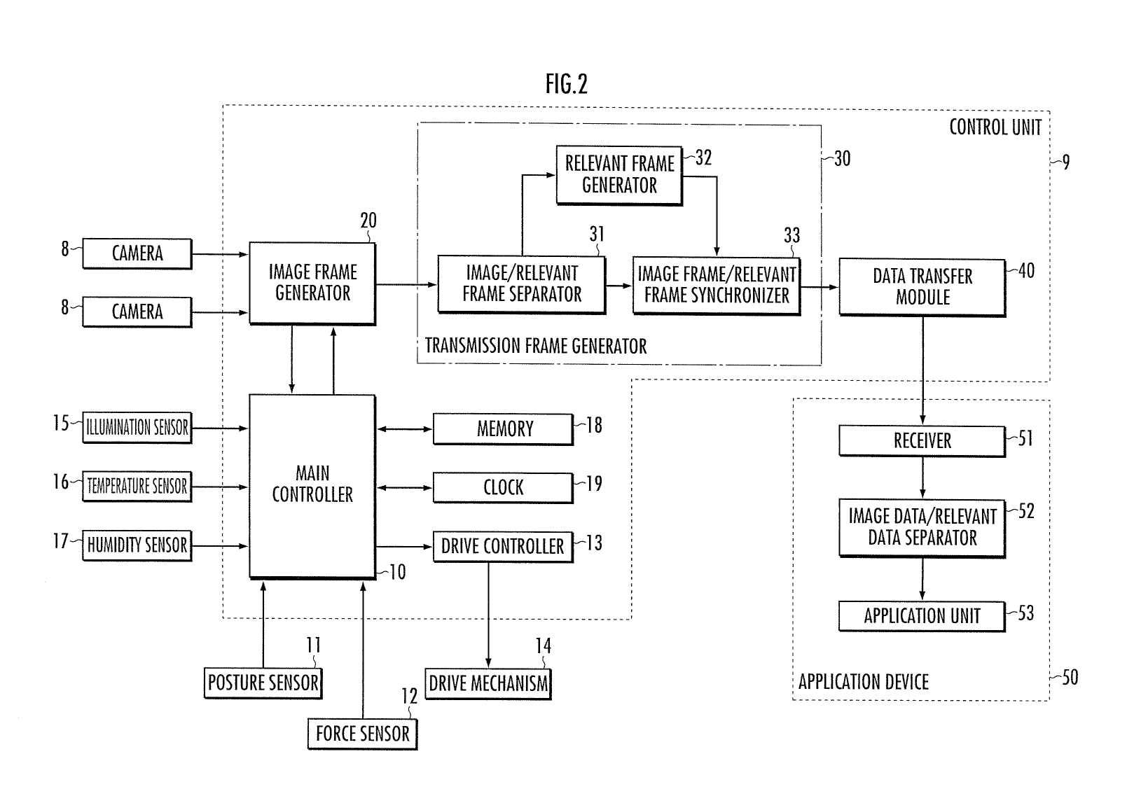

As shown in FIG. 2, the control unit 9 includes: a main controller 10 corresponding to a relevant data acquirer of the present invention; an image frame generator (image frame controller) 20; a transmission frame generator (video generator) 30; and a data transfer module (video transmitter) 40. An application device 50 to which data can be wiredly or wirelessly transmitted from the data transfer module 40 is provided separately from the robot 1.

The main controller 10 controls operations of the robot 1. The main controller 10 receives detection signals of a posture sensor 11 that detects a posture of the robot 1 and a force sensor 12 that detects an external force acting on the robot 1.

As the posture sensor 11 includes, for example, an inclination sensor mounted in the body 2 (see FIG. 1) for measuring an inclination angle of the body 2 and its rate of change (angular velocity). For instance, the inclination sensor is composed of an acceleration sensor, and a rate sensor (angular velocity sensor) such as a gyro sensor.

As the force sensor 12 includes, for example, a force sensor mounted for detecting a contact force acting on each hand 7 (see FIG. 1), and a six-axis force sensor mounted at the ankle joint of each leg 4 for detecting a translational force component of three axis directions and a moment component about three axes of a floor reaction force transmitted from the floor to the leg 4 via the foot 6.

The main controller 10 calculates a joint displacement command of each joint based on the detection signals of the posture sensor 11 and the force sensor 12 and the like, and outputs the joint displacement command to a drive controller 13. The drive controller 13 generates a drive signal necessary for an actual joint displacement to follow the joint displacement command, and outputs the drive signal to a drive mechanism 14.

The robot 1 further includes an illumination sensor 15 for detecting an external illumination, a temperature sensor 16 for detecting an external temperature, and a humidity sensor 17 for detecting an external humidity. Detection signals of these sensors 15 to 17 are output to the main controller 10. Note that information detected by these sensors 15 to 17 are used, for example, for correction of image data acquired by the pair of cameras 8.

Moreover, the control unit 9 includes a memory 18 that is formed by a memory device such as a ROM or a RAM, and stores identification data such as an ID number unique to the robot 1, model and correction data of each camera, and history data such as a detection signal of each sensor and a joint displacement command of each joint. The main controller 10 references the memory 18, to obtain data stored in the memory 18.

The control unit 9 also includes a clock 19 showing a time. The main controller 10 references the clock 19, to obtain a current time.

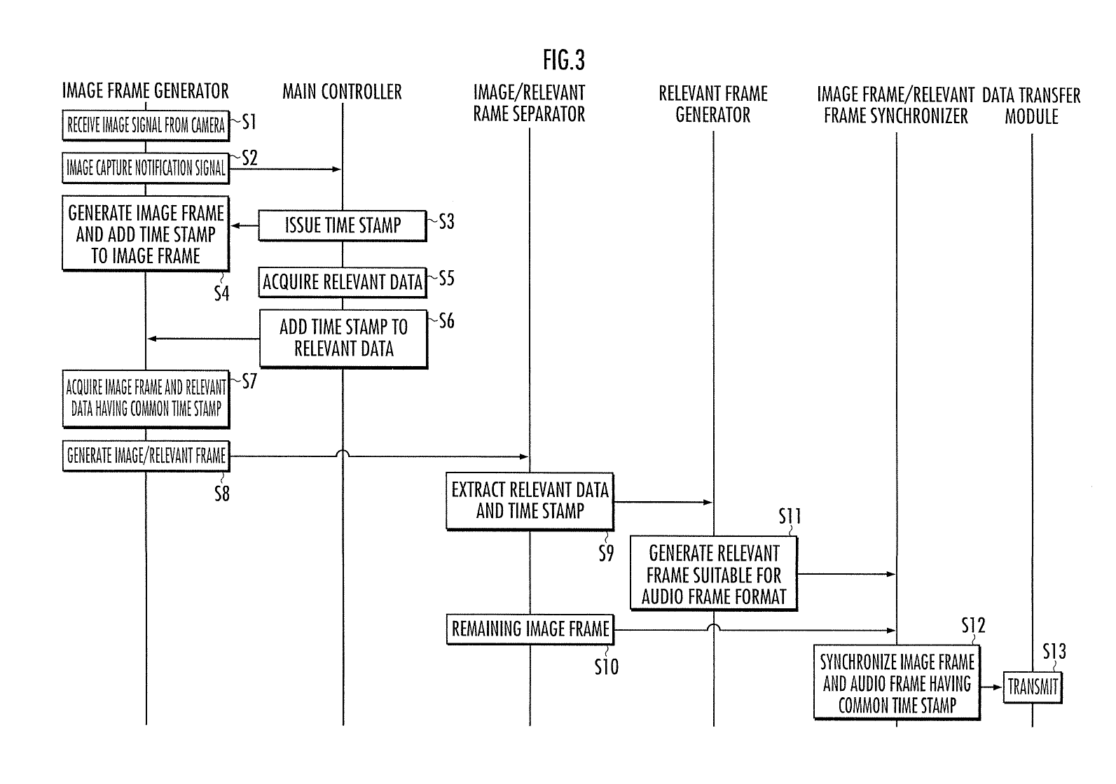

As shown in FIGS. 2 and 3, upon receiving an analog image signal from the pair of cameras 8 (S1), the image frame generator 20 outputs an image capture notification signal (shutter information) S to the main controller 10, in order to notify that image data capture starts (S2). Upon receiving the image capture notification signal S, the main controller 10 obtains the current time by referencing the clock 19, and issues a time stamp TS indicating imaging time data (S3).

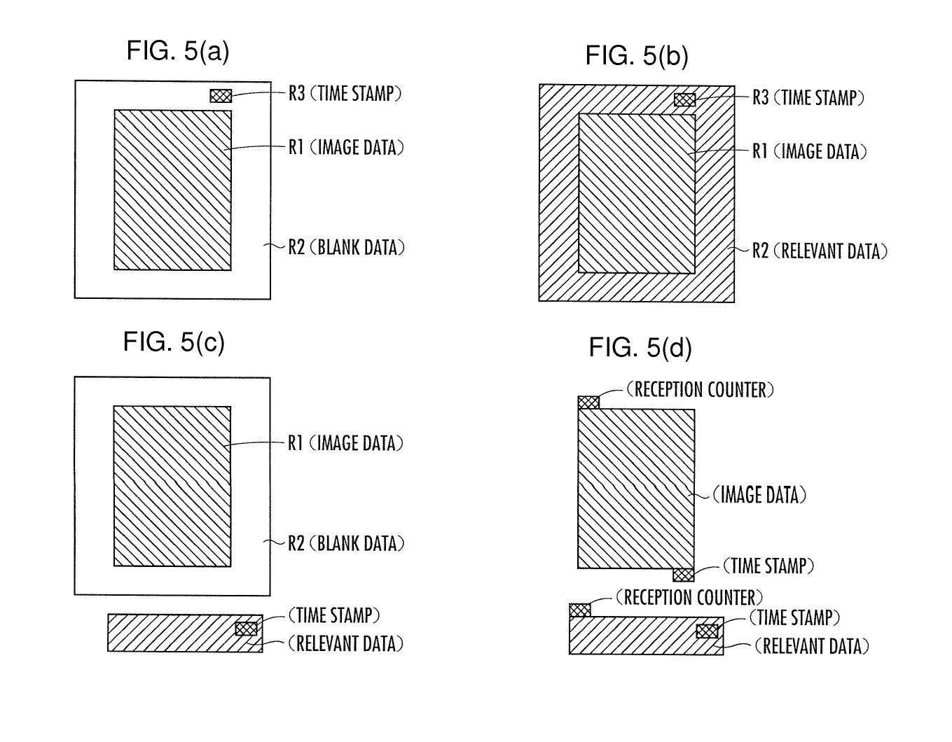

Meanwhile, the image frame generator 20 digitizes the analog signal received from the pair of cameras 8, and converts the digital signal to a frame according to a predetermined format, thereby generating an image frame. The image frame generator 20 also adds the time stamp TS issued by the main controller 10, to the image frame (S4). The format mentioned here is a format suitable for image frame transmission by the data transfer module 40. As shown in FIG. 5(a), the format is made up of an area R1 for storing image data and a blank area R2 other than the area R1. Time stamp data is stored in a predetermined area R3 which is a part of the blank area R2.

Upon receiving the image capture notification signal S, the main controller 10 acquires external relevant data indicating external information about the outside world itself and matters influencing the robot 1 from the outside, and internal relevant data indicating internal information about the robot 1 itself and the inside of the robot 1 (S5).

In the external information, the information about the outside world itself includes the external illumination, temperature, and humidity respectively detected by the illumination sensor 15, the temperature sensor 16, and the humidity sensor 17, and the information about matters influencing the robot 1 includes the external force detected by the force sensor 12 as acting on the robot 1. In the internal information, the information about the robot 1 itself includes the posture of the robot 1 detected by the posture sensor 11, and the information about the inside of the robot 1 includes the joint angle, drive velocity, and drive acceleration of each joint of the robot 1.

The main controller 10 adds the time stamp TS issued by itself, to relevant data made up of the external relevant data and the internal relevant data, and outputs the resulting relevant data to the image frame generator 20 (S6).

Note that, since there is only an extremely short time lag between a time at which the pair of cameras 8 acquire the image data and a time at which the main controller 10 receives the image capture notification signal, these times are regarded as the same time. However, alternatively, relevant data may be temporarily stored in the memory 18 with an acquisition time, to take the time lag into consideration in such a manner that relevant data acquired at the same time as image data acquisition by the pair of cameras 8 is provided with the time stamp TS indicating the time, and output to the image frame generator 20.

The image frame generator 20 acquires the relevant data having the time stamp TS in common with the image frame (S7). As shown in FIG. 5(b), the image frame generator 20 generates an image/relevant frame by storing the relevant data in the blank data area R2 outside the area R1 in which the image data is stored in the image frame, and outputs the image/relevant frame to the transmission frame generator 30 (S8).

The transmission frame generator 30 includes an image/relevant frame separator (image frame/relevant data receiver) 31, a relevant frame generator (audio frame generator) 32, and an image frame/relevant frame synchronizer (video synthesis unit) 33.

The image/relevant frame separator 31 extracts the relevant data from the received image/relevant frame, and outputs the relevant data to the relevant frame generator 32 together with the time stamp TS (S9). The image/relevant frame separator 31 also transmitts the image frame remaining after the relevant data is extracted from the image/relevant frame, to the image frame/relevant frame synchronizer 33 (S10).

In this embodiment, a video transmission and reception device is used as a transmission and reception system, and so the relevant frame is rendered as an audio frame.

The relevant frame generator 32 generates a relevant frame by storing the relevant data in an audio data storage area in an audio frame format of the data transfer module 40, using the received relevant data and time stamp TS (S11). Here, an audio signal digital transfer standard is taken as an example.

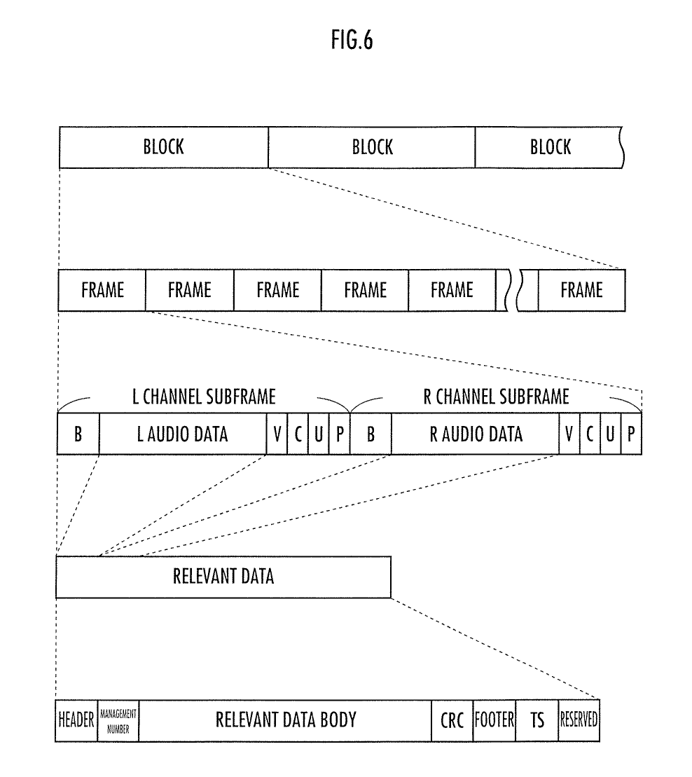

As shown in FIG. 6, in the transfer standard, one block is made up of 192 frames, and each frame is made up of two subframes, i.e., an L channel subframe and an R channel subframe. Each subframe has 32-bit data for one sample, composed of a 4-bit preamble B, 24-bit audio data, a 1-bit Validity flag V, 1-bit user data U, a 1-bit channel status C, and 1-bit parity P.

The relevant data is divided in units of 24 bits and stored in the areas that are originally intended to store audio data (the areas of L audio data and R audio data in FIG. 6). In detail, as the relevant data, a relevant data body composed of various data constituting the relevant data, and a header, a management number, an error protection CRC, a footer, a time stamp TS, and the like which accompany the relevant data are stored in the areas according to a predetermined format.

The relevant frame generator 32 outputs the generated relevant frame to the image frame/relevant frame synchronizer 33.

The image frame/relevant frame synchronizer 33 synchronizes the image frame and the relevant frame having the common time stamp TS, and outputs them to the data transfer module 40 (S12).

The data transfer module 40 codes (encodes) each of the synchronously received image frame and relevant frame according to a predetermined scheme such as MPEG to compress the frames, and transmits the compressed frames to the application device 50 (S13).

In the case of forming the data transfer module 40 by a commercially available data transfer module, there is an instance where data stored in a blank area of an image frame is not ignored and has some significance, depending on a manufacturer of the data transfer module or a transmission standard. In view of this, the relevant data stored in the blank area R2 of the image frame is extracted and blank data is stored in the blank area R2, before the image frame is input to the data transfer module 40. However, in the case of forming the data transfer module 40 by a dedicated data transfer module, the transmission may be performed in a state where the relevant data is stored in the blank area R2.

Thus, the relevant data stored in the audio data storage area in the audio format that is used when the data transfer module 40 transmits the audio frame is transmitted together with the image frame having the time stamp TS in common with the relevant data, using the data transfer module 40. This ensures that the image frame and the relevant data of the same timing as the imaging (acquisition) timing of the image frame are synchronously transmitted.

In addition, the image frame and the relevant data are synchronously transmitted using the data transfer module 40 for transmitting the image frame of the predetermined image format and the audio frame of the predetermined audio format, so that a commercially available, inexpensive data transfer module can be used as the data transfer module 40.

The application device 50 includes a receiver (video receiver) 51, an image data/relevant data separator (video separator) 52, and an application unit 53.

The receiver 51 decompresses (decodes) each of the image frame and the relevant frame synchronously received from the data transfer module 40 according to a predetermined scheme, and outputs the decompressed frames to the image data/relevant data separator 52 (S14).

As shown in FIG. 5(d), the image data/relevant data separator 52 extracts the image data and the relevant data respectively from the image frame and the relevant frame synchronously received from the receiver 51 (S15), and adds a common reception counter C to the image data and the relevant data (S16). Moreover, before completion of transfer of the image data, the image data/relevant data separator 52 extracts the time stamp TS from the relevant data, and adds the time stamp TS to the end of the image data (S17).

The image data/relevant data separators 52 then synchronously outputs the separated image data and relevant data to the application unit 53 (S18).

The application unit 53 executes a predetermined application using the received image data and relevant data (S19). Examples of the application include various image processing such as stereo image generation using image data from the pair of cameras 8, feature point extraction of an object or the like, and face recognition, monitoring such as automatic patrol based on these image processing, image saving on a regular basis or upon a status change such as a sensor detection value change, image notification, and detection of an object and recognition of its position.

Note that a processing result obtained by the application unit 53 may be transmitted to the main controller 10 and used for controlling operations of the robot 1.

Since the image data and the relevant data used for image processing or the like need to be separately processed in the application unit 53, the image data and the relevant data are separated in the image data/relevant data separator 52. Depending on the processing in the application unit 53, however, the image data and the relevant data do not need to be separated.

Though the embodiment of the present invention has been described above, the present invention is not limited to this. For example, the embodiment describes the structure in which the relevant data is output from the main controller 10 to the image/relevant frame generator 31 via the image frame generator 20, but the relevant data may instead be directly output from the main controller 10 to the image/relevant frame generator 31. Note however that, in the case where the main controller 10, the image frame generator 20, and the transmission frame generator 30 are each formed by a separate circuit board, the above-mentioned structure of the embodiment has an advantage that the transmission frame generator 30 can simply have one input source and the number of components such as cables and connectors can be reduced.

The embodiment describes the case where the robot corresponding to the mobile body of the present invention is a humanoid robot, but the present invention is not limited to this. The robot corresponding to the mobile body of the present invention need not be provided with legs, arms, hands, and the like, so long as at least a part in which an imaging device is mounted is movable.

The mobile body of the present invention is not limited to a robot. For example, the mobile body of the present invention may be a vehicle, a ship, an airplane, or a monitor capable of patrolling, so long as at least a part in which an imaging device is mounted is movable.

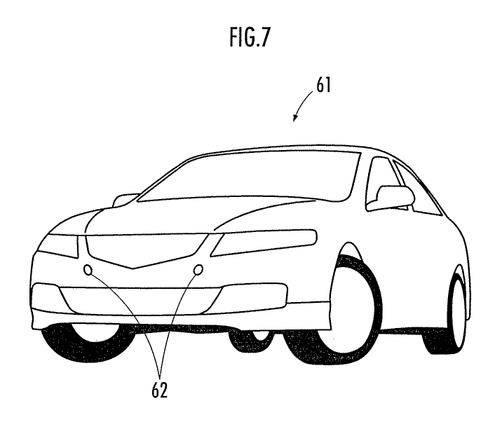

In the case where the mobile body of the present invention is a vehicle, for example, a pair of cameras 62 which are imaging devices are mounted in a vehicle 61, as shown in FIG. 7. In such a case, data indicating external information about the outside world itself and about matters influencing the vehicle 61 from the outside is acquired as external relevant data. Examples of such data include an external illumination, temperature, and humidity, and a contact pressure detected by a contact sensor mounted in a bumper or the like of the vehicle 61. Moreover, data indicating information about the vehicle 61 itself and about the inside of the vehicle 61 is acquired as internal relevant data. Examples of such data include a posture of the vehicle 61 detected by a posture sensor mounted in the vehicle 61, and a rate and acceleration of drive control of the vehicle 61.

What is claimed is:

1. A data transmission method for synchronously transmitting image data and relevant data using a data transfer module, the image data being captured by an imaging device included in a mobile body, the relevant data being data relevant to the mobile body, and the data transfer module transmitting an image frame of a predetermined image format and an audio frame of a predetermined audio format, the data transmission method comprising:
a step of acquiring the image data captured by the imaging device, together with imaging time data indicating an imaging time of the image data, and generating an image frame;
a step of acquiring the relevant data acquired at the imaging time, together with the imaging time data indicating the imaging time; and
a step of acquiring the image frame and the relevant data that have the common imaging time data, and transmitting, using the data transfer module, a relevant frame together with the image frame converted in the image format, the relevant frame being composed of the relevant data stored in an audio data storage area in the audio format.

2. The data transmission method according to claim 1, wherein when the image frame and the relevant data that have the common imaging time data are acquired, the relevant data is temporarily stored in a blank data area in the image frame, the blank data area being outside an area in which the image data is stored in the image frame.

3. The data transmission method according to claim 1, wherein the data transfer module transmits data using a lossy compression scheme.

4. The data transmission method according to claim 2, wherein the data transfer module transmits data using a lossy compression scheme.

5. The data transmission method according to claim 1, comprising
a step of receiving the image frame and the relevant data transmitted from the data transfer module, generating a reception counter indicating a time at which the image frame and the relevant data are received, and adding the reception counter to each of the image frame and the relevant data.

6. The data transmission method according to claim 2, comprising
a step of receiving the image frame and the relevant data transmitted from the data transfer module, generating a reception counter indicating a time at which the image frame and the relevant data are received, and adding the reception counter to each of the image frame and the relevant data.

7. The data transmission method according to claim 3, comprising
a step of receiving the image frame and the relevant data transmitted from the data transfer module, generating a reception counter indicating a time at which the image frame and the relevant data are received, and adding the reception counter to each of the image frame and the relevant data.

8. The data transmission method according to claim 4, comprising
a step of receiving the image frame and the relevant data transmitted from the data transfer module, generating a reception counter indicating a time at which the image frame and the relevant data are received, and adding the reception counter to each of the image frame and the relevant data.

9. A data transmission device which synchronously transmits image data and relevant data using a data transfer module, the image data being captured by an imaging device included in a mobile body, the relevant data being data relevant to the mobile body, and the data transfer module transmitting an image frame of a predetermined image format and an audio frame of a predetermined audio format, the data transmission device comprising:
an image frame generator which acquires the image data captured by the imaging device, together with imaging time data indicating an imaging time of the image data, and generates an image frame;
a relevant data acquirer which acquires the relevant data acquired at the imaging time, together with the imaging time data indicating the imaging time; and
a transmission frame generator which acquires the image frame and the relevant data that have the common imaging time data, and generates the image frame converted in the image format, and a relevant frame composed of the relevant data stored in an audio data storage area in the predetermined audio format,
wherein the image frame and the relevant data generated by the transmission frame generator is transmitted using the data transfer module.

10. The data transmission device according to claim 9, wherein the mobile body is a robot, and the relevant data acquirer acquires at least external information which is obtained by the robot from outside the robot, as the relevant data.

11. The data transmission device according to claim 9, wherein the mobile body is a robot, and the relevant data acquirer acquires at least internal information which is obtained by the robot from inside the robot, as the relevant data.

12. The data transmission device according to claim 10, wherein the relevant data acquirer acquires at least internal information which is obtained by the robot from inside the robot, as the relevant data.

13. The data transmission device according to claim 9, wherein the mobile body is a vehicle, and the relevant data acquirer acquires at least external information which is obtained by the vehicle from outside the vehicle, as the relevant data.

14. The data transmission device according to claim 9, wherein the mobile body is a vehicle, and the relevant data acquirer acquires at least internal information which is obtained by the vehicle from inside the vehicle, as the relevant data.

15. The data transmission device according to claim 13, wherein the relevant data acquirer acquires at least internal information which is obtained by the vehicle from inside the vehicle, as the relevant data.
